(19) United States
(12) Patent Application Publication
(10) Pub. No.: US 2019/0392035 A1
(43) Pub. Date: Dec. 26, 2019

(54) INFORMATION OBJECT EXTRACTION USING COMBINATION OF CLASSIFIERS ANALYZING LOCAL AND NON-LOCAL FEATURES

(71) Applicant: ABBYY Production LLC, Moscow (RU)

(72) Inventor: Evgenii Indenbom, Moscow (RU)

(21) Appl. No.: 16/017,169

(22) Filed: Jun. 25, 2018

(30) Foreign Application Priority Data
Jun. 20, 2018 (RU) 2018122445

(51) Int. Cl. G06F 17/27

(52) U.S. Cl. CPC G06F 17/277; G06F 17/278; G06F 17/271; G06F 17/2785

(57) ABSTRACT

Systems and methods for information extraction from natural language texts using a combination of classifiers analyzing local and non-local features. An example method may comprise: extracting, by a computer system, a plurality of features associated with each text segment of a plurality of text segments of a natural language text; associating one or more tags with each text segment of the plurality of text segments by processing, using a stage one classifier, the extracted features associated with the text segment; extracting, from a local context of a candidate token of a text segment of the plurality of text segments, a plurality of local features associated with the candidate token; and processing, by a stage two classifier, a combination of the plurality of local features and the tags associated with the text segment to determine a degree of association of an information object referenced by the candidate token with a category of information objects.

### REFERENCE TO RELATED APPLICATIONS

The present application claims the benefit of priority under 35 U.S.C. § 119 to Russian Patent Application No. 2018122445 filed Jun. 20, 2018, the disclosure of which is incorporated by reference herein.

### TECHNICAL FIELD

The present disclosure is generally related to computer systems, and is more specifically related to systems and methods for natural language processing.

### BACKGROUND

Information extraction may involve analyzing a natural language text to recognize information objects, such as named entities, and relationships between the recognized information objects.

### SUMMARY OF THE DISCLOSURE

In accordance with one or more aspects of the present disclosure, an example method of information extraction from natural language texts using a combination of classifier analyzing local and non-local features may comprise: extracting a plurality of features associated with each text segment of a plurality of text segments of a natural language text; associating one or more tags with each text segment of the plurality of text segments by processing, using a stage one classifier, the extracted features associated with each text segment; extracting, from a local context of a candidate token of a text segment of the plurality of text segments, a plurality of local features associated with the candidate token; and processing, by a stage two classifier, a combination of the plurality of local features and the tags associated with the text segment to determine a degree of association of an information object referenced by the candidate token with a category of information objects.

In accordance with one or more aspects of the present disclosure, an example method of training classifiers utilized for information extraction from natural language texts may comprise: receiving an annotated natural language text accompanied by metadata specifying information object categories and respective textual annotations; partitioning the annotated natural language text into a plurality of partitions; training a plurality of stage one classifiers to associate one or more tags with each text segment of a plurality of segments of natural language text, wherein each classifier is trained using a respective training data set comprising all but one partition of the plurality of partitions; producing segment-level features by applying each of the trained stage one classifiers to a partition which was excluded from a respective training data set; training a stage two classifier for processing a combination of local features and the segment-level features to determine degrees of association of textual tokens with categories of information objects.

In accordance with one or more aspects of the present disclosure, an example computer-readable non-transitory storage medium may comprise executable instructions that, when executed by a computer system, cause the computer system to: extract a plurality of features associated with each text segment of a plurality of text segments of a natural language text; associate one or more tags with each text segment of the plurality of text segments by processing, using a stage one classifier, the extracted features associated with each text segment; extract, from a local context of a candidate token of a text segment of the plurality of text segments, a plurality of local features associated with the candidate token; and process, by a stage two classifier, a combination of the plurality of local features and the tags associated with the text segment to determine a degree of association of an information object referenced by the candidate token with a category of information objects.

### BRIEF DESCRIPTION OF THE DRAWINGS

The present disclosure is illustrated by way of examples, and not by way of limitation, and may be more fully understood with references to the following detailed description when considered in connection with the figures, in which:

FIG. 1 depicts a flow diagram of an example method of information extraction from natural language texts using a combination of classifiers analyzing local and non-local features, in accordance with one or more aspects of the present disclosure;

FIG. 2 depicts a flow diagram of an example method of training classifiers utilized for information extraction from natural language texts, in accordance with one or more aspects of the present disclosure;

FIG. 3 depicts a flow diagram of one illustrative example of a method of performing a semantico-syntactic analysis of a natural language sentence, in accordance with one or more aspects of the present disclosure.

FIG. 4 schematically illustrates an example of a lexico-morphological structure of a sentence, in accordance with one or more aspects of the present disclosure;

FIG. 5 schematically illustrates language descriptions representing a model of a natural language, in accordance with one or more aspects of the present disclosure;

FIG. 6 schematically illustrates examples of morphological descriptions, in accordance with one or more aspects of the present disclosure;

FIG. 7 schematically illustrates examples of syntactic descriptions, in accordance with one or more aspects of the present disclosure;

FIG. 8 schematically illustrates examples of semantic descriptions, in accordance with one or more aspects of the present disclosure;

FIG. 9 schematically illustrates examples of lexical descriptions, in accordance with one or more aspects of the present disclosure;

FIG. 10 schematically illustrates example data structures that may be employed by one or more methods implemented in accordance with one or more aspects of the present disclosure;

FIG. 11 schematically illustrates an example graph of generalized constituents, in accordance with one or more aspects of the present disclosure;

FIG. 12 illustrates an example syntactic structure corresponding to the sentence illustrated by FIG. 11;

FIG. 13 illustrates a semantic structure corresponding to the syntactic structure of FIG. 12; and

FIG. 14 depicts a diagram of an example computer system implementing the methods described herein.

### DETAILED DESCRIPTION

Described herein are methods and systems for information extraction from natural language texts by a combination of classifiers analyzing local and non-local features. A classifier may be represented by a trainable model or a neural network that yields a degree of association of an information object referenced by textual annotation with a category of a pre-defined set of categories (e.g., ontology classes).

Information extraction may involve analyzing a natural language text to recognize information objects (such as named entities), their attributes, and their relationships. Named entity recognition (NER) is an information extraction task that locates and classifies natural language text tokens into pre-defined categories such as names of persons, organizations, locations, expressions of times, quantities, monetary values, percentages, etc. Such categories may be represented by concepts of a pre-defined or dynamically built ontology.

“Ontology” herein shall refer to a model representing objects pertaining to a certain branch of knowledge (subject area) and relationships among such objects. An information object may represent a real life material object (such as a person or a thing) or a certain notion associated with one or more real life objects (such as a number or a word). An ontology may comprise definitions of a plurality of classes, such that each class corresponds to a certain notion pertaining to a specified knowledge area. Each class definition may comprise definitions of one or more objects associated with the class. Following the generally accepted terminology, an ontology class may also be referred to as concept, and an object belonging to a class may also be referred to as an instance of the concept. An information object may be characterized by one or more attributes. An attribute may specify a property of an information object or a relationship between a given information object and another information object. Thus, an ontology class definition may comprise one or more attribute definitions describing the types of attributes that may be associated with objects of the given class (e.g., type of relationships between objects of the given class and other information objects). In an illustrative example, a class “Person” may be associated with one or more information objects corresponding to certain persons. In another illustrative example, an information object “John Smith” may have an attribute “Smith” of the type “surname.”

Once the named entities have been recognized, the information extraction may proceed to resolve co-references and anaphoric links between natural text tokens. “Co-reference” herein shall mean a natural language construct involving two or more natural language tokens that refer to the same entity (e.g., the same person, thing, place, or organization). For example, in the sentence “Upon his graduation from MIT, John was offered a position by Microsoft,” the proper noun “John” and the possessive pronoun “his” refer to the same person. Out of two co-referential tokens, the referenced token may be referred to as the antecedent, and the referring one as a proform or anaphora. Various methods of resolving co-references may involve performing syntactic and/or semantic analysis of at least a part of the natural language text.

Once the information objects have been extracted and co-references have been resolved, the information extraction may proceed to identify relationships between the extracted information objects. One or more relationships between the information object and other information objects may be specified by one or more properties of an information object that are reflected by one or more attributes. A relationship may be established between two information objects, between a given information object and a group of information objects, or between one group of information objects and another group of information objects. Such relationships and attributes may be expressed by natural language fragments (textual annotations) that may comprise a plurality of words of one or more sentences.

In an illustrative example, an information object of the class “Person” may have the following attributes: name, date of birth, residential address, and employment history. Each attribute may be represented by one or more textual strings, one or more numeric values, and/or one or more values of a specified data type (e.g., date). An attribute may be represented by a complex attribute referencing two or more information objects. In an illustrative example, the “address” attribute may reference information objects representing a numbered building, a street, a city, and a state. In an illustrative example, the “employment history” attribute may reference one or more information objects representing one or more employers and associated positions and employment dates.

Certain relationships among information objects may be also referred to as “facts.” Examples of such relationships include employment of person X by organization Y, location of a physical object X in geographical position Y, acquiring of organization X by organization Y, etc. a fact may be associated with one or more fact categories, such that a fact category indicates a type of relationship between information objects of specified classes. For example, a fact associated with a person may be related to the person's birth date and place, education, occupation, employment, etc. In another example, a fact associated with a business transaction may be related to the type of transaction and the parties to the transaction, the obligations of the parties, the date of signing the agreement, the date of the performance, the payments under the agreement, etc. Fact extraction involves identifying various relationships among the extracted information objects.

An information object may be represented by a constituent of a syntactico-semantic structure and a subset of its immediate child constituents. A contiguous text fragment (or “span” including one or more words) corresponding to such a sub-tree represents a textual annotation of the information object. The textual annotation may be specified by its position in the text, including the starting position and the ending position.

In various common implementations, information extraction may involve analyzing lexical, grammatical, syntactic and/or semantic features in order to determine the degree of association of a text token (or a corresponding syntactico-semantic structure constituent) with a certain information object category (e.g., represented by an ontology class). The scope of analyzed features is usually limited to the local context of the candidate token, since the number of such features may grow exponentially as the context under consideration widens, thus causing the exponential growth of the computational complexity of the information extraction task. However, certain texts may be structured in such a manner that the local context may not always contain classification features which may be suitable for information extraction. In an illustrative example, parties to a contract may be defined in the contract preamble, and then may be referenced, often along with various third parties, in the body of the contract. Such references may employ short names, abbreviations, etc., which may be defined in the contract preamble, thus rendering the local context of a text segment fully contained by the contract body to be inadequate for information extraction.

The present disclosure addresses this and other deficiencies of various common implementations by employing a two-stage classification technique, in which the first stage yields the degree of association of each text segment (e.g., a sentence, a paragraph, or another identifiable part of the natural language text) with one or more information object categories and thus associates corresponding tags with the text segment, while the second stage involves analyzing the combination of these text segment tags and the local context of a candidate constituent for determining the degree of association of the candidate constituent with specified information object categories.

Thus, the present disclosure improves the efficiency and quality of information extraction by providing classification systems and methods that utilize local and non-local features for information extraction. Systems and methods described herein may be implemented by hardware (e.g., general purpose and/or specialized processing devices, and/or other devices and associated circuitry), software (e.g., instructions executable by a processing device), or a combination thereof. Various aspects of the above referenced methods and systems are described in detail herein below by way of examples, rather than by way of limitation.

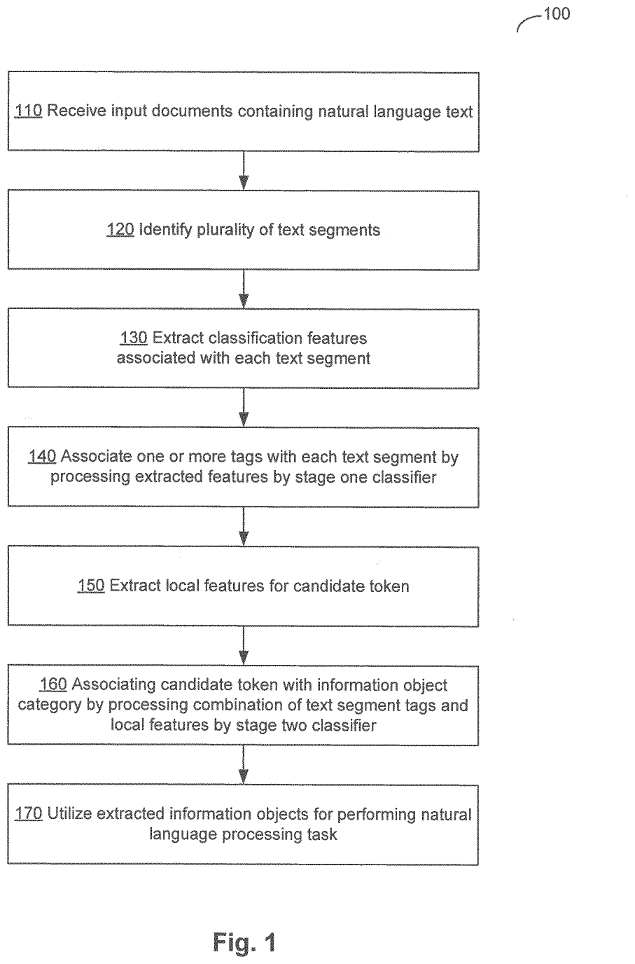

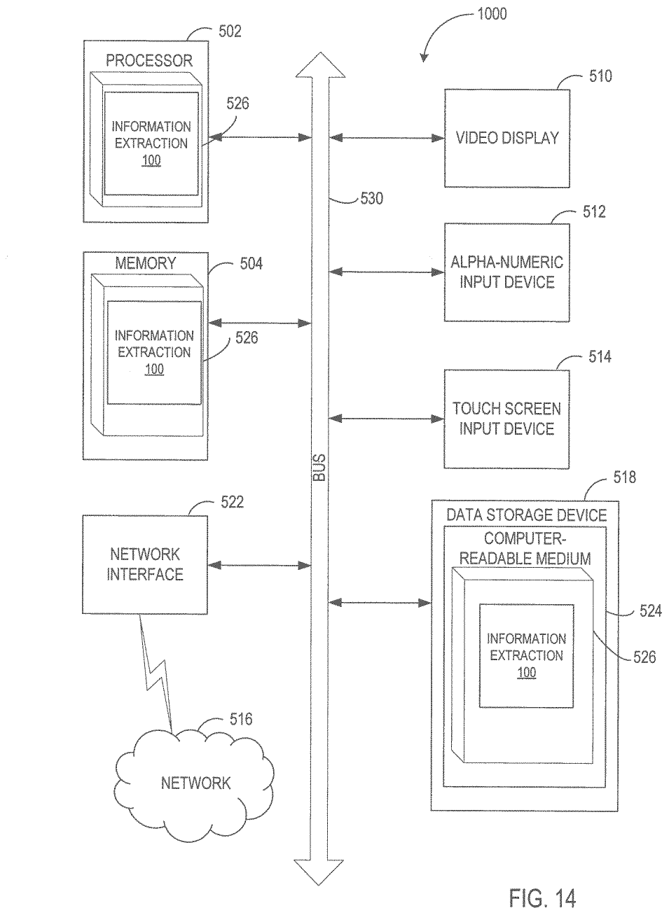

FIG. 1 depicts a flow diagram of an example method of information extraction from natural language texts using a combination of classifiers analyzing local and non-local features, in accordance with one or more aspects of the present disclosure. Method 100 and/or each of its individual functions, routines, subroutines, or operations may be performed by one or more processors of the computer system (e.g., computer system 1000 of FIG. 14) implementing the method. In certain implementations, method 100 may be performed by a single processing thread. Alternatively, method 100 may be performed by two or more processing threads, each thread implementing one or more individual functions, routines, subroutines, or operations of the method. In an illustrative example, the processing threads implementing method 100 may be synchronized (e.g., using semaphores, critical sections, and/or other thread synchronization mechanisms). Alternatively, the processing threads implementing method 100 may be executed asynchronously with respect to each other. Therefore, while FIG. 1 and the associated description lists the operations of method 100 in certain order, various implementations of the method may perform at least some of the described operations in parallel and/or in arbitrary selected orders.

At block 110, the computer system implementing method 100 may receive one or more input documents containing a natural language text. In various illustrative examples, the natural language text to be processed by method 100 may be retrieved by scanning or otherwise acquiring images of one or more paper documents and performing optical character recognition (OCR) to produce the respective natural language texts. The natural language text may be also retrieved from various other sources including electronic mail messages, social networks, audio files processed by speech recognition methods, etc.

At block 120, the computer system may identify a plurality of text segments in the natural language text. In various illustrative example, a text segment may be represented by a sentence, a paragraph, or another identifiable part of the natural language text. In identifying the segments, the computer system may analyze the document physical and/or logical layout, including the table of contents, logical or visual dividers, etc.

At block 130, the computer system may, for each identified document segment, extract a plurality of classification features associated with the segment. In an illustrative example, the features may include a “bag of words,” i.e., an unordered or arbitrarily ordered set of words contained by the text segment. Therefore, the features may be represented by a vector, each element of which is an integer value reflecting the number of occurrences in the text segment of the word identified by the index of the element.

In order to reduce the level of noise which may be caused by certain frequently occurring words (e.g., articles, prepositions, auxiliary verbs, etc.), the features may be represented by a vector of term frequency-inverse document frequency (TF-IDF) values.

Term frequency (TF) represents the frequency of occurrence of a given word in the text segment:

tf(t,d)=nₜ/Σnₖ

where t is the word identifier,

d is the text segment identifier,

nₜ is the number of occurrences of the word t within text segment d, and

Σnₖ is the total number of words within text segment d.

Inverse document frequency (IDF) is defined as the logarithmic ratio of the number of texts in the corpus being analyzed to the number of texts containing the given word:

idf(t,D)=log[|D|/|{diϵD|tϵdi}|]

where D is the text corpus identifier,

|D| is the number of texts in the corpus, and

{diϵD|tϵdi} is the number of texts of the corpus D which contain the word t.

Thus, TF-IDF may be defined as the product of the term frequency (TF) and the inverse document frequency (IDF):

tf-idf(t,d,D)=tf(t,d)*idf(t,D)

Accordingly, the features may be represented by a vector, each element of which is an integer value reflecting the TF-IDF value of the word identified by the index of the element. TF-IDF would produce larger values for words that are more frequently occurring in one text segment that in other text segments of the corpus.

In various alternative implementations, other types of features which may be extracted from text segments, including morphological, syntactical, and/or semantic features, may be utilized in addition to or instead of the above-described bag of words or TF-IDF values.

At block 140, the computer system may, for each identified document segment, process the extracted text segment features by one or more stage one classifiers, such that each stage one classifier yields the degree of association of the text segment with a certain information object category. The computer system may then associate the text segments with one or more tags corresponding to the information object categories for which the degree of association produced by the respective classifier exceeds a pre-defined threshold value.

In an illustrative example, a tag may indicate a presence in the text segment of a reference to an information object of a certain information object category (e.g., a paragraph containing at least one word indicating a person would be associated with a tag <P.Person>, where “P” identifies the text segment type (paragraph) and “Person” identifies the information object category referenced by at least one token contained in the paragraph). Accordingly, the features extracted from a given paragraph may be fed to multiple classifiers, such that each classifier corresponds to an information object category, and the paragraph may be associated with one or more tags corresponding to the respective information object categories.

Alternatively, other segment categories may be utilized. In an illustrative example, the segment categories may correspond to logical document parts, e.g., “Preamble,” “Parties to the contract,” “Obligations of the parties,” “Covenants,” and/or other parts of a structure corresponding to a certain document type (e.g., “Contract”). Thus, in certain implementations, operations referenced by block 140 may be viewed as reconstructing the logical document structure.

Accordingly, in an illustrative example, the output of operations referenced by block 140 may be represented, for each text segment, by one or more tags associated with the text segment. In another illustrative example, the output of operations referenced by block 140 may be represented, for each text segment, by one or more values reflecting the degree of association of the text segment with a corresponding segment category.

In various illustrative examples, the stage one classifiers employed by operations performed by block 140 may be implemented by a gradient boosting classifier, random forest classifier, support vector machine (SVM) classifier, and/or other suitable automatic classification methods. The classifiers may be trained on an annotated text corpus, as described in more detail herein below.

At blocks 150-160, the computer system may iterate through at least a subset of candidate tokens of the natural language text in order to identify the category of the information object referenced each candidate token. In particular, at block 150, the computer system may analyze the natural language text to extract, from the local context of each candidate token, a plurality of local features associated with the candidate token. The local context may include various combinations of neighbors of the candidate token.

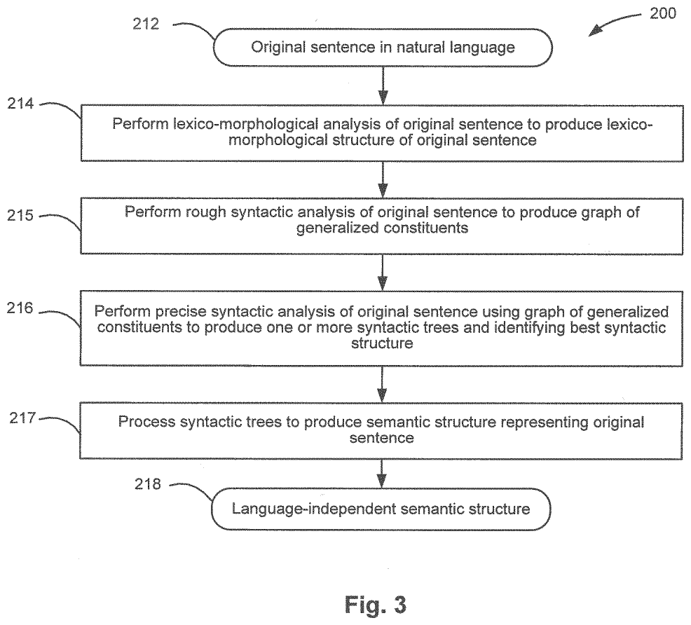

In various illustrative examples, analyzing the natural language text may involve performing lexico-morphological analysis, syntactic analysis, and/or semantic analysis of a text segment in order to produce one or more lexico-morphological, syntactic, and/or syntactico-semantic structures and their attributes, as described in more detail herein below with references to FIGS. 3-13.

The extracted classification features of the candidate token may include semantic class identifiers associated with the local context of the candidate token, lexical class identifiers associated with the local context of the candidate token, pragmatic class identifiers associated with the local context of the candidate token, syntactic paradigm identifier associated with the local context of the candidate token, grammeme identifiers associated with the local context of the candidate token, semanteme identifiers associated with the local context of the candidate token, capitalization patterns associated with the local context of the candidate token, deep slot identifiers associated with the local context of the candidate token, identifiers of the left and/or right punctuator associated with the local context of the candidate token, etc. In certain implementations, the initial set of classification features may be processed in order to identify a subset of the most informative features, based on one or more statistical criteria which evaluate the ability of a classifier model to produce the most number of correct outputs based on the subset of features being evaluated.

At block 160, the computer system may employ one or more stage two classifiers to process the combination of the extracted local features and text segment tags produced by operations of block 140 for the text segment in which the candidate token is found. Each stage two classifier may yield the degree of association of the candidate token with a certain information object category. The computer system may then associate the candidate token with the information object categories for which the degree of association produced by the respective stage two classifier exceeds a pre-defined threshold value.

In various illustrative examples, each classifier employed by operations performed by block 160 may be implemented by a gradient boosting classifier, random forest classifier, support vector machine (SVM) classifier, neural network, and/or other suitable automatic classification methods. The classifiers may be trained on an annotated text corpus, as described in more detail herein below.

In certain implementations, the computer system may represent the extracted information objects and their attributes by an (Resource Description Framework) RDF graph. The Resource Description Framework assigns a unique identifier to each information object and stores the information regarding such an object in the form of SPO triplets, where S stands for “subject” and contains the identifier of the object, P stands for “predicate” and identifies an attribute of the object, and O stands for “object” and stores the attribute value. This value can be either a primitive data type (string, number, Boolean value) or an identifier of another object. In an illustrative example, an SPO triplet may associate a natural language text fragment with a category of named entities.

In certain implementations, the computer system may display the extracted information objects in visual association with the respective textual annotations. The computer system may further accept the user input confirming or modifying the extracted information objects and/or their attributes. In certain implementations, the user input may be utilized for updating the training data set that is employed for adjusting classifier parameters.

At block 170, the computer system may utilize the extracted information objects for performing various natural language processing tasks, such as machine translation, semantic search, document classification, clustering, text filtering, etc. Responsive to completing the operations described with references to block 170, the method may terminate.

As noted herein above, values of one or more classifier parameters may be determined by supervised learning methods. The supervise learning may involve iteratively modifying the parameter values based on processing a training data set including a plurality of annotated natural language texts, in order to optimize a specified fitness function. In an illustrative example, the fitness function may be represented by the F-measure metric produced by evaluating the information objects yielded by the classifier, which is defined as follows:

F_{β}=(1+β²)*(Precision*Recall)/((β²*Precision)+Recall),

where Precision=tₚ/(tₚ+fₚ) and Recall=tₚ/(tₚ+fₙ),

tₚ is the number of true positive outcomes (correctly classified extracted information objects), fₚ is the number of false positive outcomes (an information object which does not belong to a certain class has been classified as belonging to that class), and fₙ is the number of false negative outcomes (an information object belonging to a certain class has not been classified as belonging to that class).

A training data set may be produced by processing one or more annotated natural language texts. An annotated text may include a plurality of annotations, such that each annotation specifies a contiguous text fragment and the types of information object represented by the text fragment. The training data set may include various features of the respective constituents, including semantic class identifiers, lexical class identifiers, pragmatic class identifiers, syntactic paradigm identifiers, grammeme identifiers, semanteme identifiers, capitalization patterns, deep slot identifiers, identifiers of the left and/or right punctuator, presence of a specified context, etc. The features may be represented by “name=value” vectors as described in more detail herein above.

In an illustrative example, the training data set may comprise a plurality of texts accompanied by metadata specifying information objects, their categories and corresponding textual attributes. Stage one classifiers, which are employed, as referenced by block 140 of FIG. 1, for tagging the text segments, may be trained to re-construct the segment-level tagging, i.e., a text segment would be tagged with <P.A> tag if it includes at least one textual annotation to an information object of category A. In certain implementations, a text segment may be associated with one or more tags corresponding to the information object categories for which the degree of association produced by the respective classifier exceeds a pre-defined threshold value. Thus, the stage one classifier may produce, for each text segment, its associated tags and their respective confidence levels (i.e., degrees of associations with the corresponding information object category). The input features for stage one classifiers may include “bags of words” for each text segment, TF-IDF values for each text segment, and/or other features, including morphological, syntactical, and/or semantic features.

Stage two classifiers, which are employed, as referenced by block 170 of FIG. 1, for extracting information objects and producing textual annotations, may be trained to process the combination of local features and text segment tags produced by stage one classifiers. In order to prevent utilizing possibly over-fitted results produced by stage one classifiers for training stage two classifiers, the annotated text corpus utilized for training the stage one classifiers may be partitioned into multiple partitions, which may then be used for training multiple stage one classifiers, such that each stage one classifier is trained using all but one partitions. Each of the trained stage one classifiers may then be utilized for processing the partition which was excluded from training the respective stage one classifier, in order to produce the segment-level features (e.g., tags) associated with the text segments of that partition. Accordingly, each stage one classifier is trained on all but one partitions and is then employed produce the segment-level features of the remaining partition. The segment-level features produced by the stage one classifiers are then combined with the metadata of the annotated text corpus in order to train the stage two classifiers, each of which processes the combination of local features and segment-level features (e.g., tags associated with text segments) in order to determine the degree of association of a candidate textual token with a certain information object category.

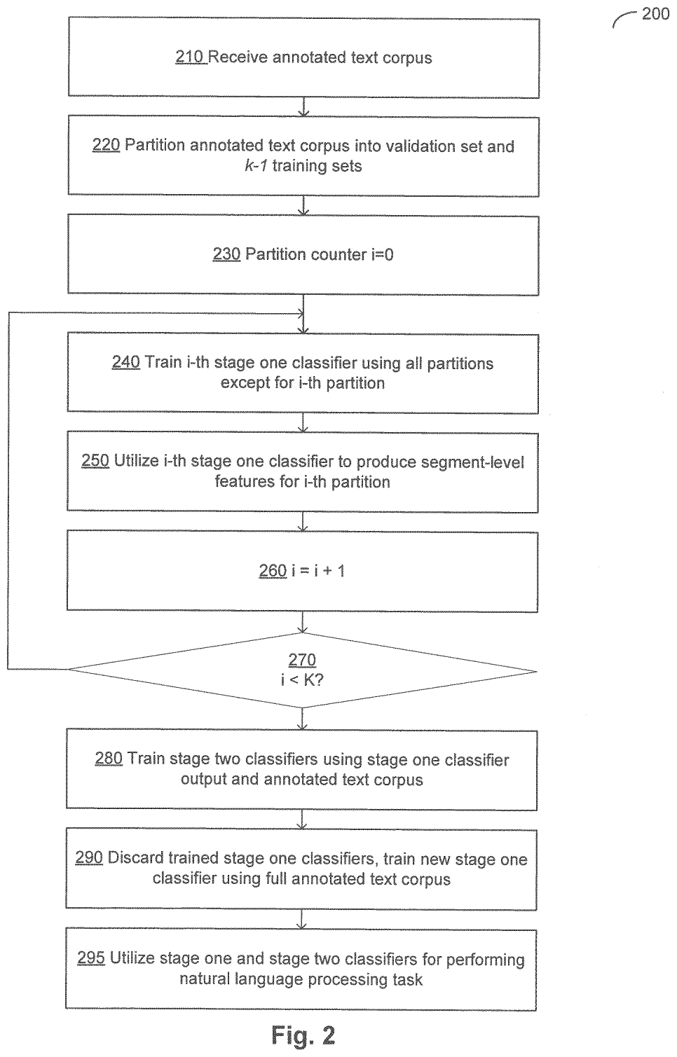

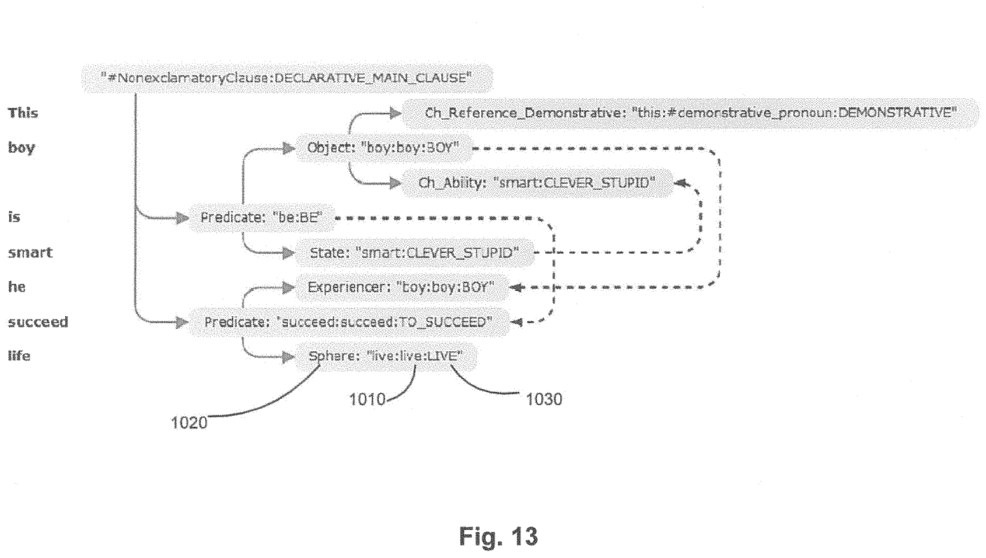

FIG. 2 depicts a flow diagram of an example method of training classifiers utilized for information extraction from natural language texts, in accordance with one or more aspects of the present disclosure. Method 200 and/or each of its individual functions, routines, subroutines, or operations may be performed by one or more processors of the computer system (e.g., computer system 1000 of FIG. 13) implementing the method. In certain implementations, method 200 may be performed by a single processing thread. Alternatively, method 200 may be performed by two or more processing threads, each thread implementing one or more individual functions, routines, subroutines, or operations of the method. In an illustrative example, the processing threads implementing method 200 may be synchronized (e.g., using semaphores, critical sections, and/or other thread synchronization mechanisms). Alternatively, the processing threads implementing method 200 may be executed asynchronously with respect to each other.

At block 210, a computer system implementing the method may receive an annotated text corpus including multiple natural language texts accompanied by metadata specifying the information objects and corresponding textual features, as described in more details herein above.

At block 220, the computer system may randomly partition the text corpus into a plurality of partitions of a substantially equal size.

At blocks 230-270, the computer system may iterate through the partitions. In particular, at block 230, the computer system may initialize the partition counter.

At block 240, the computer system may train a stage one classifier on a training data set which includes all partitions except for the partition referenced by the current value of the partition counter. The stage one classifiers may be trained to re-construct the segment-level tagging of the respective training data sets, i.e., to produce, for each text segment, its associated tags and their respective confidence levels. The input features for stage one classifiers may include “bags of words” for each text segment, TF-IDF values for each text segment, and/or other features, including morphological, syntactical, and/or semantic features, as described in more detail herein above.

At block 250, the computer system may utilize each of the trained stage one classifiers to process the partition referenced by the current value of the partition counter (i.e., the partition which was excluded from the training data set utilized for training the respective classifier), thus re-producing the segment level tagging for that partition.

At block 260, the computer system may increment the partition counter.

Responsive to determining, at block 270, that the partition counter has not yet reached the total number of partitions, the method may loop back to block 240. Otherwise, at block 280, the computer system may combine the segment-level features produced by the stage one classifiers with the metadata of the annotated text corpus in order to train one or more the stage two classifiers, each of which would process the combination of local features and segment-level features (e.g., tags associated with text segments) in order to determine the degree of association of a candidate textual token with a certain information object category.

At block 290, the computer system may discard the trained stage one classifiers and train a new stage one classifier utilizing the full annotated text corpus.

At block 295, the computer system may utilize the trained stage one and stage two classifiers for performing various natural language processing tasks, such as machine translation, semantic search, document classification, clustering, text filtering, etc. Responsive to completing the operations described with references to block 280, the method may terminate.

FIG. 3 depicts a flow diagram of one illustrative example of a method 200 for performing a semantico-syntactic analysis of a natural language sentence 212, in accordance with one or more aspects of the present disclosure. Method 200 may be applied to one or more syntactic units (e.g., sentences) comprised by a certain text corpus, in order to produce a plurality of semantico-syntactic trees corresponding to the syntactic units. In various illustrative examples, the natural language sentences to be processed by method 200 may be retrieved from one or more electronic documents which may be produced by scanning or otherwise acquiring images of paper documents and performing optical character recognition (OCR) to produce the texts associated with the documents. The natural language sentences may be also retrieved from various other sources including electronic mail messages, social networks, digital content files processed by speech recognition methods, etc.

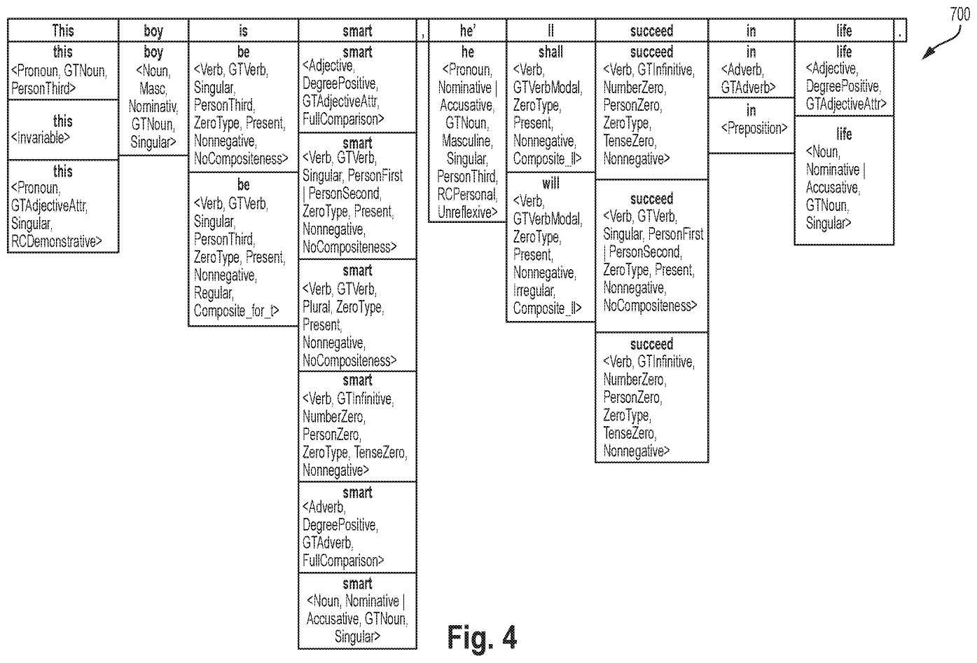

At block 214, the computer system implementing the method may perform lexico-morphological analysis of sentence 212 to identify morphological meanings of the words comprised by the sentence. “Morphological meaning” of a word herein shall refer to one or more lemmas (i.e., canonical or dictionary forms) corresponding to the word and a corresponding set of values of grammatical features defining the grammatical value of the word. Such grammatical features may include the lexical category of the word and one or more morphological features (e.g., grammatical case, gender, number, conjugation type, etc.). Due to homonymy and/or coinciding grammatical forms corresponding to different lexico-morphological meanings of a certain word, two or more morphological meanings may be identified for a given word. An illustrative example of performing lexico-morphological analysis of a sentence is described in more detail herein below with references to FIG. 4.

At block 215, the computer system may perform a rough syntactic analysis of sentence 212. The rough syntactic analysis may include identification of one or more syntactic models which may be associated with sentence 212 followed by identification of the surface (i.e., syntactic) associations within sentence 212, in order to produce a graph of generalized constituents. “Constituent” herein shall refer to a contiguous group of words of the original sentence, which behaves as a single grammatical entity. A constituent comprises a core represented by one or more words, and may further comprise one or more child constituents at lower levels. A child constituent is a dependent constituent and may be associated with one or more parent constituents.

At block 216, the computer system may perform a precise syntactic analysis of sentence 212, to produce one or more syntactic trees of the sentence. The pluralism of possible syntactic trees corresponding to a given original sentence may stem from homonymy and/or coinciding grammatical forms corresponding to different lexico-morphological meanings of one or more words within the original sentence. Among the multiple syntactic trees, one or more best syntactic trees corresponding to sentence 212 may be selected, based on a certain quality metric function taking into account compatibility of lexical meanings of the original sentence words, surface relationships, deep relationships, etc.

At block 217, the computer system may process the syntactic trees to produce a semantic structure 218 corresponding to sentence 212. Semantic structure 218 may comprise a plurality of nodes corresponding to semantic classes, and may further comprise a plurality of edges corresponding to semantic relationships, as described in more detail herein below.

FIG. 4 schematically illustrates an example of a lexico-morphological structure of a sentence, in accordance with one or more aspects of the present disclosure. Example lexical-morphological structure 700 may comprise a plurality of “lexical meaning-grammatical value” pairs for example sentence. In an illustrative example, “ll” may be associated with lexical meaning “shall” and “will”. The grammatical value associated with lexical meaning “shall” is <Verb, GTVerbModal, ZeroType, Present, Nonnegative, Composite II>. The grammatical value associated with lexical meaning “will” is <Verb, GTVerbModal, ZeroType, Present, Nonnegative, Irregular, Composite II>.

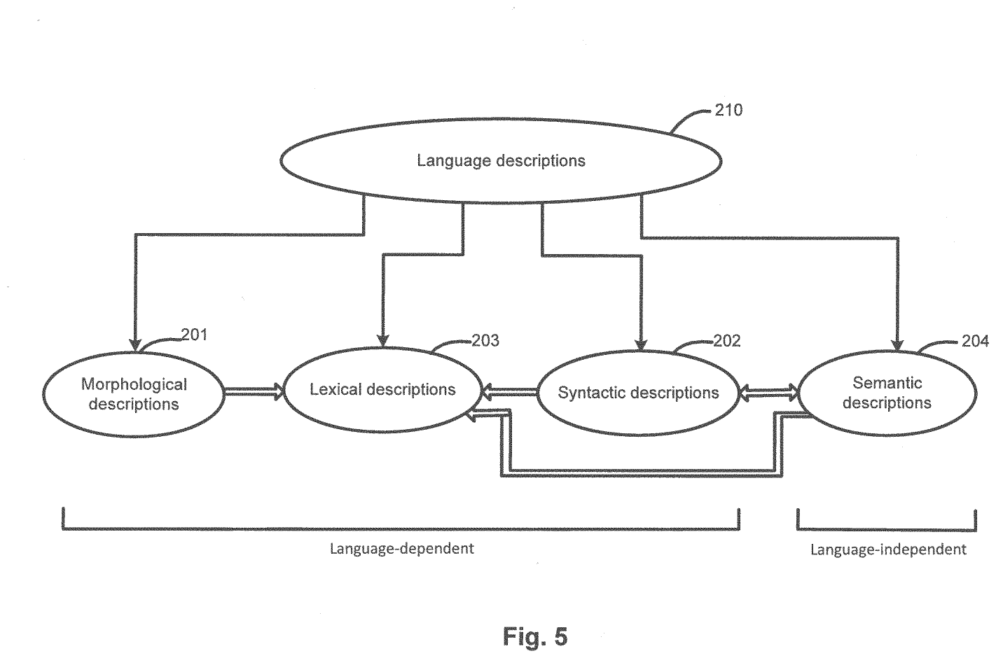

FIG. 5 schematically illustrates language descriptions 210 including morphological descriptions 201, lexical descriptions 203, syntactic descriptions 202, and semantic descriptions 204, and their relationship thereof. Among them, morphological descriptions 201, lexical descriptions 203, and syntactic descriptions 202 are language-specific. A set of language descriptions 210 represent a model of a certain natural language.

In an illustrative example, a certain lexical meaning of lexical descriptions 203 may be associated with one or more surface models of syntactic descriptions 202 corresponding to this lexical meaning. A certain surface model of syntactic descriptions 202 may be associated with a deep model of semantic descriptions 204.

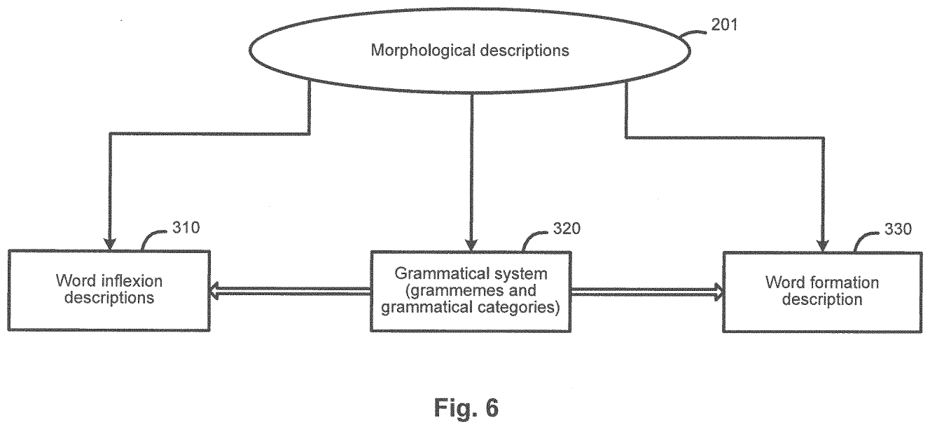

FIG. 6 schematically illustrates several examples of morphological descriptions. Components of the morphological descriptions 201 may include: word inflexion descriptions 310, grammatical system 320, and word formation description 330, among others. Grammatical system 320 comprises a set of grammatical categories, such as, part of speech, grammatical case, grammatical gender, grammatical number, grammatical person, grammatical reflexivity, grammatical tense, grammatical aspect, and their values (also referred to as “grammemes”), including, for example, adjective, noun, or verb; nominative, accusative, or genitive case; feminine, masculine, or neutral gender; etc. The respective grammemes may be utilized to produce word inflexion description 310 and the word formation description 330.

Word inflexion descriptions 310 describe the forms of a given word depending upon its grammatical categories (e.g., grammatical case, grammatical gender, grammatical number, grammatical tense, etc.), and broadly includes or describes various possible forms of the word. Word formation description 330 describes which new words may be constructed based on a given word (e.g., compound words).

According to one aspect of the present disclosure, syntactic relationships among the elements of the original sentence may be established using a constituent model. A constituent may comprise a group of neighboring words in a sentence that behaves as a single entity. A constituent has a word at its core and may comprise child constituents at lower levels. A child constituent is a dependent constituent and may be associated with other constituents (such as parent constituents) for building the syntactic descriptions 202 of the original sentence.

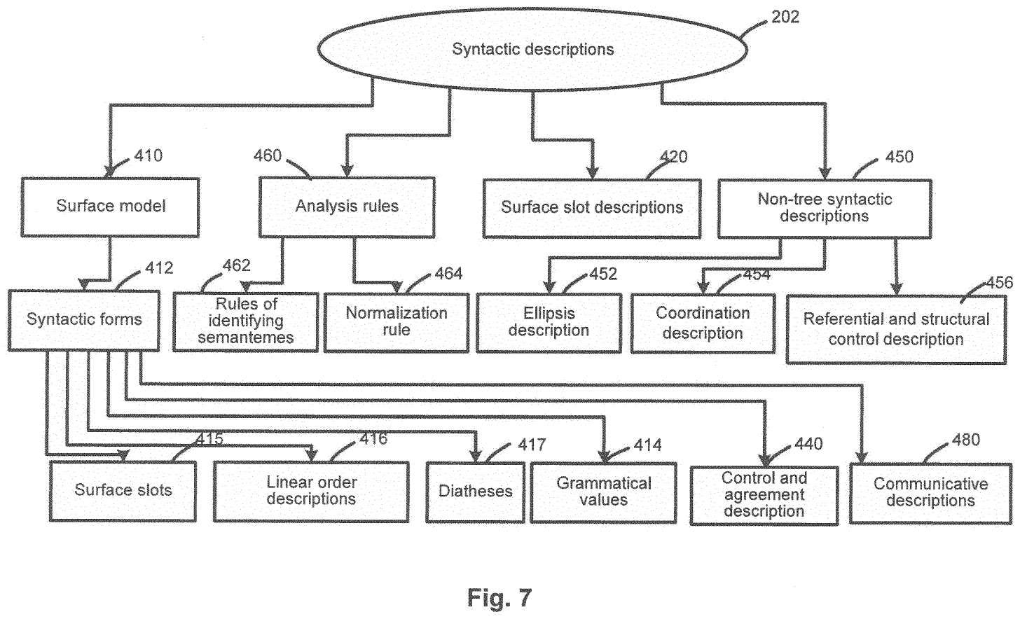

FIG. 7 illustrates exemplary syntactic descriptions. The components of the syntactic descriptions 202 may include, but are not limited to, surface models 410, surface slot descriptions 420, referential and structural control description 456, control and agreement description 440, non-tree syntactic description 450, and analysis rules 460. Syntactic descriptions 102 may be used to construct possible syntactic structures of the original sentence in a given natural language, taking into account free linear word order, non-tree syntactic phenomena (e.g., coordination, ellipsis, etc.), referential relationships, and other considerations.

Surface models 410 may be represented as aggregates of one or more syntactic forms (“syntforms” 412) employed to describe possible syntactic structures of the sentences that are comprised by syntactic description 102. In general, the lexical meaning of a natural language word may be linked to surface (syntactic) models 410. A surface model may represent constituents which are viable when the lexical meaning functions as the “core.” A surface model may include a set of surface slots of the child elements, a description of the linear order, and/or diatheses. “Diathesis” herein shall refer to a certain relationship between an actor (subject) and one or more objects, having their syntactic roles defined by morphological and/or syntactic means. In an illustrative example, a diathesis may be represented by a voice of a verb: when the subject is the agent of the action, the verb is in the active voice, and when the subject is the target of the action, the verb is in the passive voice.

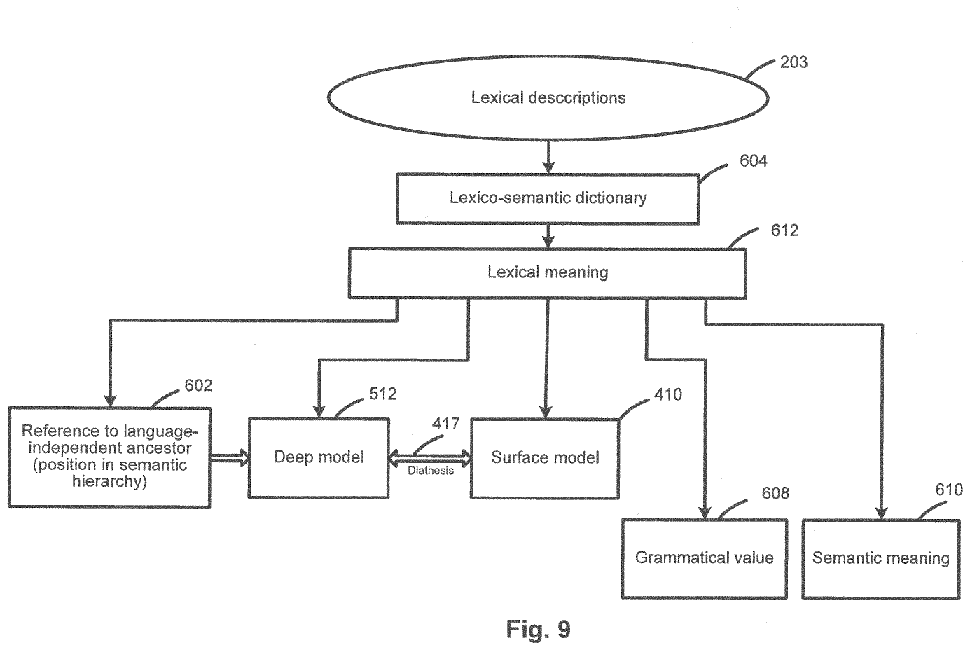

A constituent model may utilize a plurality of surface slots 415 of the child constituents and their linear order descriptions 416 to describe grammatical values 414 of possible fillers of these surface slots. Diatheses 417 may represent relationships between surface slots 415 and deep slots 514 (as shown in FIG. 9). Communicative descriptions 480 describe communicative order in a sentence.

Linear order description 416 may be represented by linear order expressions reflecting the sequence in which various surface slots 415 may appear in the sentence. The linear order expressions may include names of variables, names of surface slots, parenthesis, grammemes, ratings, the “or” operator, etc. In an illustrative example, a linear order description of a simple sentence of “Boys play football” may be represented as “Subject Core Object_Direct,” where Subject, Core, and Object_Direct are the names of surface slots 415 corresponding to the word order.

Communicative descriptions 480 may describe a word order in a syntform 412 from the point of view of communicative acts that are represented as communicative order expressions, which are similar to linear order expressions. The control and concord description 440 may comprise rules and restrictions which are associated with grammatical values of the related constituents and may be used in performing syntactic analysis.

Non-tree syntax descriptions 450 may be created to reflect various linguistic phenomena, such as ellipsis and coordination, and may be used in syntactic structures transformations which are generated at various stages of the analysis according to one or more aspects of the present disclosure. Non-tree syntax descriptions 450 may include ellipsis description 452, coordination description 454, as well as referential and structural control description 430, among others.

Analysis rules 460 may generally describe properties of a specific language and may be used in performing the semantic analysis. Analysis rules 460 may comprise rules of identifying semantemes 462 and normalization rules 464. Normalization rules 464 may be used for describing language-dependent transformations of semantic structures.

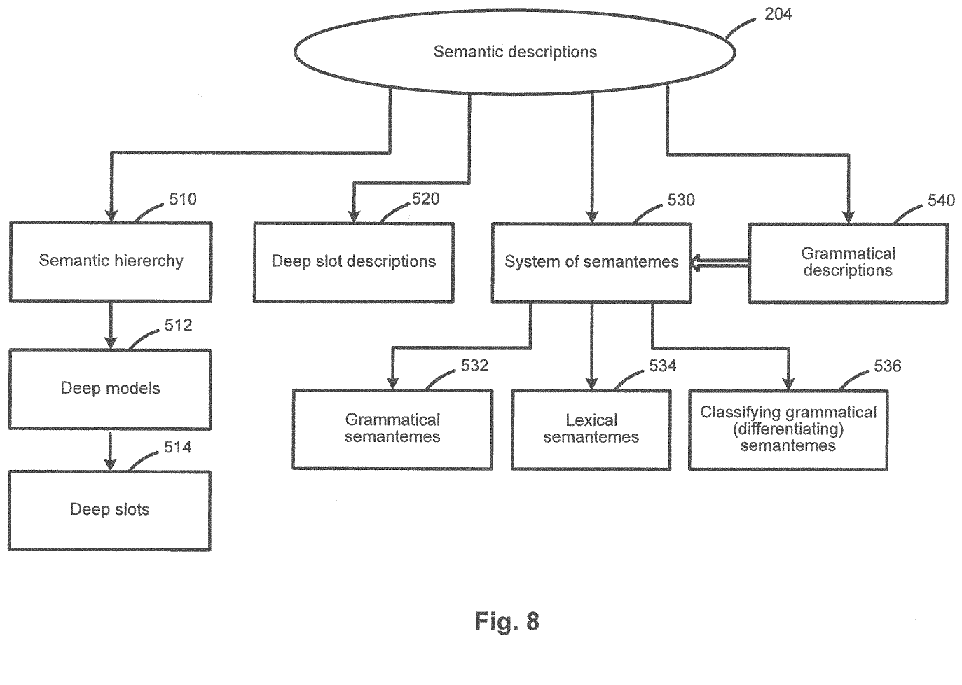

FIG. 8 illustrates exemplary semantic descriptions. Components of semantic descriptions 204 are language-independent and may include, but are not limited to, a semantic hierarchy 510, deep slots descriptions 520, a set of semantemes 530, and pragmatic descriptions 540.

The core of the semantic descriptions may be represented by semantic hierarchy 510 which may comprise semantic notions (semantic entities) which are also referred to as semantic classes. The latter may be arranged into hierarchical structure reflecting parent-child relationships. In general, a child semantic class may inherit one or more properties of its direct parent and other ancestor semantic classes. In an illustrative example, semantic class SUBSTANCE is a child of semantic class ENTITY and the parent of semantic classes GAS, LIQUID, METAL, WOOD_MATERIAL, etc.

Each semantic class in semantic hierarchy 510 may be associated with a corresponding deep model 512. Deep model 512 of a semantic class may comprise a plurality of deep slots 514 which may reflect semantic roles of child constituents in various sentences that include objects of the semantic class as the core of the parent constituent. Deep model 512 may further comprise possible semantic classes acting as fillers of the deep slots. Deep slots 514 may express semantic relationships, including, for example, “agent,” “addressee,” “instrument,” “quantity,” etc. A child semantic class may inherit and further expand the deep model of its direct parent semantic class.

Deep slots descriptions 520 reflect semantic roles of child constituents in deep models 512 and may be used to describe general properties of deep slots 514. Deep slots descriptions 520 may also comprise grammatical and semantic restrictions associated with the fillers of deep slots 514. Properties and restrictions associated with deep slots 514 and their possible fillers in various languages may be substantially similar and often identical. Thus, deep slots 514 are language-independent.

System of semantemes 530 may represents a plurality of semantic categories and semantemes which represent meanings of the semantic categories. In an illustrative example, a semantic category “DegreeOfComparison” may be used to describe the degree of comparison and may comprise the following semantemes: “Positive,” “ComparativeHigherDegree,” and “SuperlativeHighestDegree,” among others. In another illustrative example, a semantic category “RelationToReferencePoint” may be used to describe an order (spatial or temporal in a broad sense of the words being analyzed), such as before or after a reference point, and may comprise the semantemes “Previous” and “Subsequent.”. In yet another illustrative example, a semantic category “EvaluationObjective” can be used to describe an objective assessment, such as “Bad,” “Good,” etc.

System of semantemes 530 may include language-independent semantic features which may express not only semantic properties but also stylistic, pragmatic and communicative properties. Certain semantemes may be used to express an atomic meaning which corresponds to a regular grammatical and/or lexical expression in a natural language. By their intended purpose and usage, sets of semantemes may be categorized, e.g., as grammatical semantemes 532, lexical semantemes 534, and classifying grammatical (differentiating) semantemes 536.

Grammatical semantemes 532 may be used to describe grammatical properties of the constituents when transforming a syntactic tree into a semantic structure. Lexical semantemes 534 may describe specific properties of objects (e.g., “being flat” or “being liquid”) and may be used in deep slot descriptions 520 as restriction associated with the deep slot fillers (e.g., for the verbs “face (with)” and “flood,” respectively). Classifying grammatical (differentiating) semantemes 536 may express the differentiating properties of objects within a single semantic class. In an illustrative example, in the semantic class of HAIRDRESSER, the semanteme of <<RelatedToMen>> is associated with the lexical meaning of “barber,” to differentiate from other lexical meanings which also belong to this class, such as “hairdresser,” “hairstylist,” etc. Using these language-independent semantic properties that may be expressed by elements of semantic description, including semantic classes, deep slots, and semantemes, may be employed for extracting the semantic information, in accordance with one or more aspects of the present invention.

Pragmatic descriptions 540 allow associating a certain theme, style or genre to texts and objects of semantic hierarchy 510 (e.g., “Economic Policy,” “Foreign Policy,” “Justice,” “Legislation,” “Trade,” “Finance,” etc.). Pragmatic properties may also be expressed by semantemes. In an illustrative example, the pragmatic context may be taken into consideration during the semantic analysis phase.

FIG. 9 illustrates exemplary lexical descriptions. Lexical descriptions 203 represent a plurality of lexical meanings 612, in a certain natural language, for each component of a sentence. For a lexical meaning 612, a relationship 602 to its language-independent semantic parent may be established to indicate the location of a given lexical meaning in semantic hierarchy 510.

A lexical meaning 612 of lexical-semantic hierarchy 510 may be associated with a surface model 410 which, in turn, may be associated, by one or more diatheses 417, with a corresponding deep model 512. A lexical meaning 612 may inherit the semantic class of its parent, and may further specify its deep model 512.

A surface model 410 of a lexical meaning may comprise includes one or more syntforms 412. A syntform, 412 of a surface model 410 may comprise one or more surface slots 415, including their respective linear order descriptions 416, one or more grammatical values 414 expressed as a set of grammatical categories (grammemes), one or more semantic restrictions associated with surface slot fillers, and one or more of the diatheses 417. Semantic restrictions associated with a certain surface slot filler may be represented by one or more semantic classes, whose objects can fill the surface slot.

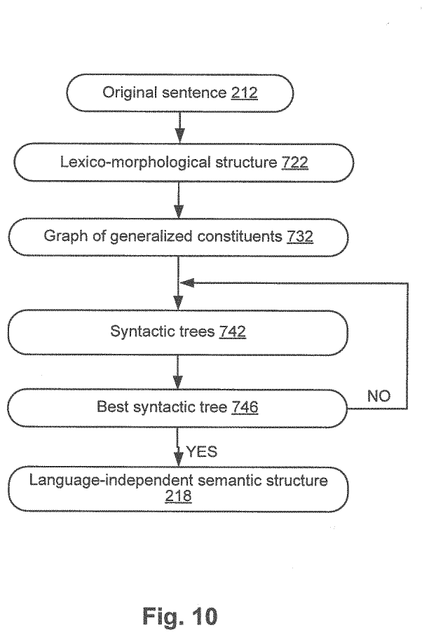

FIG. 10 schematically illustrates example data structures that may be employed by one or more methods described herein. Referring again to FIG. 3, at block 214, the computer system implementing the method may perform lexico-morphological analysis of sentence 212 to produce a lexico-morphological structure 722 of FIG. 10. Lexico-morphological structure 722 may comprise a plurality of mapping of a lexical meaning to a grammatical value for each lexical unit (e.g., word) of the original sentence. FIG. 4 schematically illustrates an example of a lexico-morphological structure.

Referring again to FIG. 3, at block 215, the computer system may perform a rough syntactic analysis of original sentence 212, in order to produce a graph of generalized constituents 732 of FIG. 10. Rough syntactic analysis involves applying one or more possible syntactic models of possible lexical meanings to each element of a plurality of elements of the lexico-morphological structure 722, in order to identify a plurality of potential syntactic relationships within original sentence 212, which are represented by graph of generalized constituents 732.

Graph of generalized constituents 732 may be represented by an acyclic graph comprising a plurality of nodes corresponding to the generalized constituents of original sentence 212, and further comprising a plurality of edges corresponding to the surface (syntactic) slots, which may express various types of relationship among the generalized lexical meanings. The method may apply a plurality of potentially viable syntactic models for each element of a plurality of elements of the lexico-morphological structure of original sentence 212 in order to produce a set of core constituents of original sentence 212. Then, the method may consider a plurality of viable syntactic models and syntactic structures of original sentence 212 in order to produce graph of generalized constituents 732 based on a set of constituents. Graph of generalized constituents 732 at the level of the surface model may reflect a plurality of viable relationships among the words of original sentence 212. As the number of viable syntactic structures may be relatively large, graph of generalized constituents 732 may generally comprise redundant information, including relatively large numbers of lexical meaning for certain nodes and/or surface slots for certain edges of the graph.

Graph of generalized constituents 732 may be initially built as a tree, starting with the terminal nodes (leaves) and moving towards the root, by adding child components to fill surface slots 415 of a plurality of parent constituents in order to reflect all lexical units of original sentence 212.

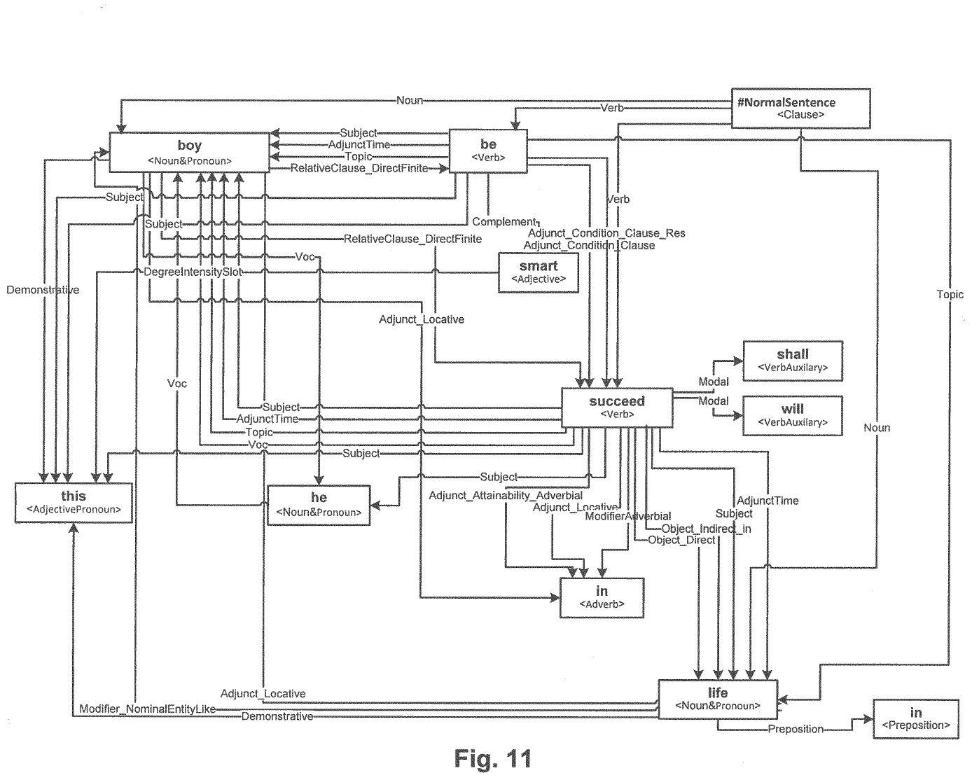

In certain implementations, the root of graph of generalized constituents 732 represents a predicate. In the course of the above described process, the tree may become a graph, as certain constituents of a lower level may be included into one or more constituents of an upper level. A plurality of constituents that represent certain elements of the lexico-morphological structure may then be generalized to produce generalized constituents. The constituents may be generalized based on their lexical meanings or grammatical values 414, e.g., based on part of speech designations and their relationships. FIG. 11 schematically illustrates an example graph of generalized constituents.

Referring again to FIG. 3, at block 216, the computer system may perform a precise syntactic analysis of sentence 212, to produce one or more syntactic trees 742 of FIG. 10 based on graph of generalized constituents 732. For each of one or more syntactic trees, the computer system may determine a general rating based on certain calculations and a priori estimates. The tree having the optimal rating may be selected for producing the best syntactic structure 746 of original sentence 212.

In the course of producing the syntactic structure based on the selected syntactic tree, the computer system may establish one or more non-tree links (e.g., by producing redundant path between at least two nodes of the graph). If that process fails, the computer system may select a syntactic tree having a suboptimal rating closest to the optimal rating, and may attempt to establish one or more non-tree relationships within that tree. Finally, the precise syntactic analysis produces a syntactic structure which represents the best syntactic structure corresponding to original sentence 212. In fact, selecting the best syntactic structure also produces the best lexical values 240 of original sentence 212.

At block 217, the computer system may process the syntactic trees to produce a semantic structure 218 corresponding to sentence 212. Semantic structure 218 may reflect, in language-independent terms, the semantics conveyed by original sentence. Semantic structure 218 may be represented by an acyclic graph (e.g., a tree complemented by at least one non-tree link, such as an edge producing a redundant path among at least two nodes of the graph). The original natural language words are represented by the nodes corresponding to language-independent semantic classes of semantic hierarchy 510. The edges of the graph represent deep (semantic) relationships between the nodes. Semantic structure 218 may be produced based on analysis rules 460, and may involve associating, one or more features (reflecting lexical, syntactic, and/or semantic properties of the words of original sentence 212) with each semantic class.

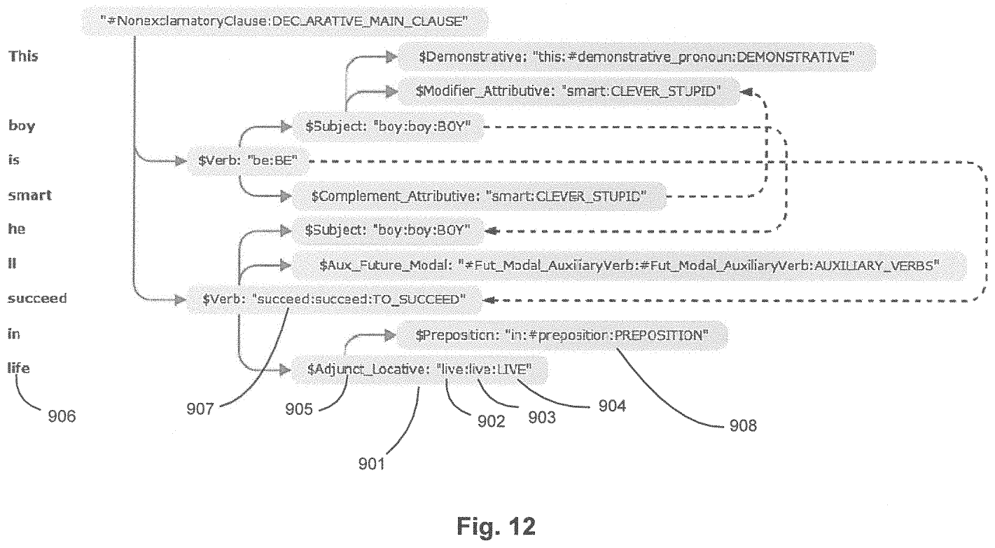

FIG. 12 illustrates an example syntactic structure of a sentence derived from the graph of generalized constituents illustrated by FIG. 11. Node 901 corresponds to the lexical element “life” 906 in original sentence 212. By applying the method of syntactico-semantic analysis described herein, the computer system may establish that lexical element “life” 906 represents one of the lexemes of a lexical meaning “live” associated with a semantic class “LIVE” 904, and fills in a surface slot $Adjunctr_Locative (905) of the parent constituent, which is represented by a controlling node $Verb:succeed:succeed:TO_SUCCEED (907).

FIG. 13 illustrates a semantic structure corresponding to the syntactic structure of FIG. 12. With respect to the above referenced lexical element “life” 906 of FIG. 12, the semantic structure comprises lexical class 1010 and semantic classes 1030 similar to those of FIG. 12, but instead of surface slot 905, the semantic structure comprises a deep slot “Sphere” 1020.

In accordance with one or more aspects of the present disclosure, the computer system implementing the methods described herein may index one or more parameters yielded by the semantico-syntactic analysis. Thus, the methods described herein allow considering not only the plurality of words comprised by the original text corpus, but also pluralities of lexical meanings of those words, by storing and indexing all syntactic and semantic information produced in the course of syntactic and semantic analysis of each sentence of the original text corpus. Such information may further comprise the data produced in the course of intermediate stages of the analysis, the results of lexical selection, including the results produced in the course of resolving the ambiguities caused by homonymy and/or coinciding grammatical forms corresponding to different lexico-morphological meanings of certain words of the original language.

One or more indexes may be produced for each semantic structure. An index may be represented by a memory data structure, such as a table, comprising a plurality of entries. Each entry may represent a mapping of a certain semantic structure element (e.g., one or more words, a syntactic relationship, a morphological, lexical, syntactic or semantic property, or a syntactic or semantic structure) to one or more identifiers (or addresses) of occurrences of the semantic structure element within the original text.

In certain implementations, an index may comprise one or more values of morphological, syntactic, lexical, and/or semantic parameters. These values may be produced in the course of the two-stage semantic analysis, as described in more detail herein. The index may be employed in various natural language processing tasks, including the task of performing semantic search.

The computer system implementing the method may extract a wide spectrum of lexical, grammatical, syntactic, pragmatic, and/or semantic characteristics in the course of performing the syntactico-semantic analysis and producing semantic structures. In an illustrative example, the system may extract and store certain lexical information, associations of certain lexical units with semantic classes, information regarding grammatical forms and linear order, information regarding syntactic relationships and surface slots, information regarding the usage of certain forms, aspects, tonality (e.g., positive and negative), deep slots, non-tree links, semantemes, etc.

The computer system implementing the methods described herein may produce, by performing one or more text analysis methods described herein, and index any one or more parameters of the language descriptions, including lexical meanings, semantic classes, grammemes, semantemes, etc. Semantic class indexing may be employed in various natural language processing tasks, including semantic search, classification, clustering, text filtering, etc. Indexing lexical meanings (rather than indexing words) allows searching not only words and forms of words, but also lexical meanings, i.e., words having certain lexical meanings. The computer system implementing the methods described herein may also store and index the syntactic and semantic structures produced by one or more text analysis methods described herein, for employing those structures and/or indexes in semantic search, classification, clustering, and document filtering.

FIG. 14 illustrates a diagram of an example computer system 1000 which may execute a set of instructions for causing the computer system to perform any one or more of the methods discussed herein. The computer system may be connected to other computer system in a LAN, an intranet, an extranet, or the Internet. The computer system may operate in the capacity of a server or a client computer system in client-server network environment, or as a peer computer system in a peer-to-peer (or distributed) network environment. The computer system may be a provided by a personal computer (PC), a tablet PC, a set-top box (STB), a Personal Digital Assistant (PDA), a cellular telephone, or any computer system capable of executing a set of instructions (sequential or otherwise) that specify operations to be performed by that computer system. Further, while only a single computer system is illustrated, the term “computer system” shall also be taken to include any collection of computer systems that individually or jointly execute a set (or multiple sets) of instructions to perform any one or more of the methodologies discussed herein.

Exemplary computer system 1000 includes a processor 502, a main memory 504 (e.g., read-only memory (ROM) or dynamic random access memory (DRAM)), and a data storage device 518, which communicate with each other via a bus 530.

Processor 502 may be represented by one or more general-purpose computer systems such as a microprocessor, central processing unit, or the like. More particularly, processor 502 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. Processor 502 may also be one or more special-purpose computer systems such as an application specific integrated circuit (ASIC), a field programmable gate array (FPGA), a digital signal processor (DSP), network processor, or the like. Processor 502 is configured to execute instructions 526 for performing the operations and functions discussed herein.

Computer system 1000 may further include a network interface device 522, a video display unit 510, a character input device 512 (e.g., a keyboard), and a touch screen input device 514.

Data storage device 518 may include a computer-readable storage medium 524 on which is stored one or more sets of instructions 526 embodying any one or more of the methodologies or functions described herein. Instructions 526 may also reside, completely or at least partially, within main memory 504 and/or within processor 502 during execution thereof by computer system 1000, main memory 504 and processor 502 also constituting computer-readable storage media. Instructions 526 may further be transmitted or received over network 516 via network interface device 522.

In certain implementations, instructions 526 may include instructions of method 100 for information extraction from natural language texts using a combination of classifier models analyzing local and non-local features, in accordance with one or more aspects of the present disclosure. While computer-readable storage medium 524 is shown in the example of FIG. 8 to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and software components, or only in software.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “determining,” “computing,” “calculating,” “obtaining,” “identifying,” “modifying” or the like, refer to the actions and processes of a computer system, or similar electronic computer system, that manipulates and transforms data represented as physical (e.g., electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

It is to be understood that the above description is intended to be illustrative, and not restrictive. Various other implementations will be apparent to those of skill in the art upon reading and understanding the above description. The scope of the disclosure should, therefore, be determined with reference to the appended claims, along with the full scope of equivalents to which such claims are entitled.

What is claimed is:

1. A method, comprising:
extracting, by a computer system, a plurality of features associated with each text segment of a plurality of text segments of a natural language text;
associating one or more tags with each text segment of the plurality of text segments by processing, using a stage one classifier, the extracted features associated with each text segment;
extracting, from a local context of a candidate token of a text segment of the plurality of text segments, a plurality of local features associated with the candidate token; and
processing, by a stage two classifier, a combination of the plurality of local features and the tags associated with the text segment to determine a degree of association of an information object referenced by the candidate token with a category of information objects.

2. The method of claim 1, wherein extracting the plurality of local features further comprises performing at least one of: lexical analysis of the natural language text or syntactico-semantic analysis of the natural language text.

3. The method of claim 1, further comprising:
identifying, within the text segment, a textual annotation associated with the information object.

4. The method of claim 1, further comprising:
utilizing the degree of association of the information object with the category of information objects for performing a natural language processing task.

5. The method of claim 1, further comprising:
displaying a textual annotation of the information object in a visual association with the category of information objects.

6. The method of claim 1, wherein the plurality of features associated with the text segment comprise at least one of: a bag of words of the text segment or a vector of term frequency-inverse document frequency (TF-IDF) values representing the text segments.

7. The method of claim 1, wherein a tag associated with a text segment indicates a presence in the text segment of a reference to an information object of a certain information object category.

8. The method of claim 1, wherein the stage one classifier is provided by one of: a gradient boosting classifier, a random forest classifier, or a support vector machine (SVM) classifier.

9. The method of claim 1, wherein the stage two classifier is provided by one of: a gradient boosting classifier, a random forest classifier, a support vector machine (SVM) classifier, or a neural network.

10. A method, comprising:
receiving, by a computer system, an annotated natural language text accompanied by metadata specifying information object categories and respective textual annotations;
partitioning the annotated natural language text into a plurality of partitions;
training a plurality of stage one classifiers to associate one or more tags with each text segment of a plurality of segments of natural language text, wherein each classifier is trained using a respective training data set comprising all but one partition of the plurality of partitions;
producing segment-level features by applying each of the trained stage one classifiers to a partition which was excluded from a respective training data set;
training a stage two classifier for processing a combination of local features and the segment-level features to determine degrees of association of textual tokens with categories of information objects.

11. The method of claim 10, further comprising:
discarding the plurality of stage one classifiers; and
training a stage one classifier utilizing the plurality of partitions of the natural language text.

12. The method of claim 11, further comprising:
utilizing the trained stage one classifier and the trained stage two classifier for performing a natural language processing task.

13. The method of claim 10, wherein the stage one classifier is provided by one of: a gradient boosting classifier, a random forest classifier, or a support vector machine (SVM) classifier.

14. The method of claim 10, wherein the stage two classifier is provided by one of: a gradient boosting classifier, a random forest classifier, a support vector machine (SVM) classifier, or a neural network.

15. A computer-readable non-transitory storage medium comprising executable instructions that, when executed by a computer system, cause the computer system to:
extract a plurality of features associated with each text segment of a plurality of text segments of a natural language text;
associate one or more tags with each text segment of the plurality of text segments by processing, using a stage one classifier, the extracted features associated with each text segment;
extract, from a local context of a candidate token of a text segment of the plurality of text segments, a plurality of local features associated with the candidate token; and
process, by a stage two classifier, a combination of the plurality of local features and the tags associated with the text segment to determine a degree of association of an information object referenced by the candidate token with a category of information objects.

16. The computer-readable non-transitory storage medium of claim 15, further comprising executable instructions causing the computer system to:
identify, within the text segment, a textual annotation associated with the information object.

17. The computer-readable non-transitory storage medium of claim 15, further comprising executable instructions causing the computer system to:
utilize the degree of association of the information object with the category of information objects for performing a natural language processing task.

18. The computer-readable non-transitory storage medium of claim 15, further comprising executable instructions causing the computer system to:
display a textual annotation of the information object in a visual association with the category of information objects.

19. The computer-readable non-transitory storage medium of claim 15, wherein the plurality of features associated with the text segment comprise at least one of: a bag of words of the text segment or a vector of term frequency-inverse document frequency (TF-IDF) values representing the text segments.

20. The computer-readable non-transitory storage medium of claim 15, wherein a tag associated with a text segment indicates a presence in the text segment of a reference to an information object of a certain information object category.
